(19) United States
(12) Patent Application Publication
(10) Pub. No.: US 2011/0309625 A1
(43) Pub. Date: Dec. 22, 2011

(54) DIRECT DRIVE DISTRIBUTED GENERATOR INTEGRATED WITH STAYED ROTOR

(75) Inventors: James G.P. Dehlsen, Montecito, CA (US); Alex Fleming, Santa Barbara, CA (US); James B. Dehlsen, Montecito, CA (US)

(73) Assignee: ECOMERIT TECHNOLOGIES LLC, Carpinteria, CA (US)

(21) Appl. No.: 12/821,074

(22) Filed: Jun. 22, 2010

(51) Int. Cl. F03D 9/00; F03D 1/06; B64C 27/00; H02K 7/102

(52) U.S. Cl. 290/55; 310/77; 416/196 A; 416/1

(57) ABSTRACT

A wind turbine power generation system incorporates a turbine rotor having a plurality of blades extending from a hub with each blade having an inner blade and an outer blade. A collar is provided on each blade with the inner blade extending between the hub and collar and the outer blade extending from the collar. A generator ring is carried by the collars and includes a generator rotor attached to the collars to rotate with the turbine rotor. A stator ring is supported from the generator rotor by a low friction interface for relative rotation with the generator rotor. A torque stay system prevents rotation of the stator ring for generation of power from the rotating turbine rotor as a linear distributed generator.

### BACKGROUND

1. Field

This application relates generally to the field of large rotor turbines for wind power generation and more particularly to a structure for a large diameter direct drive generator integrated with a stayed wind turbine rotor.

2. Related Art

Wind turbines that reach multi-megawatt scale have large diameter low speed rotors (8-15 RPM). Typically, such wind turbines require a high step-up in rotational speed through a gearbox to provide economic generator and system efficiency. While there are gearbox designs suitable for the low RPM and high torque characteristic of very large wind turbines, these are large, complex heavy machines that require a very high degree of precision in manufacturing and assembly, and where component change-out in the field or offshore can be problematic. Some multi-megawatt wind turbines use a direct drive generator, which requires a large diameter (10M+) generator to attain gap speed sufficient for economic operation. Prior art conventional direct drive wind turbines with a large diameter generator require substantial structural mass to maintain tight, uniform gap clearance, on the order of one quarter of an inch or less to achieve electromagnetic efficiency.

It is therefore desirable to provide a wind turbine generator system which eliminates the need for a low RPM, high-torque gearbox in large conventional wind turbines. It is further desirable to provide a high gap speed with a large diameter system and that such system benefits from an appropriate structural design. The high-gap speed also makes it desirable to utilize a bearing design of the rotor/stator interface, which minimizes frictional losses.

It is additionally desirable to create such a generator system with efficient use of active material (permanent magnets and wound electromagnets) by maintaining a uniform, tight air gap clearance. It is also desirable to provide these elements in a manner eliminating large, heavy support structure used in conventional direct drive in low RPM wind turbines. Finally, it is desirable that such a system be easily maintainable.

### SUMMARY

Exemplary embodiments provide a wind turbine power generation system incorporating a turbine rotor having a plurality of blades extending from a hub with each blade having an inner blade and an outer blade. A collar is provided on each blade with the inner blade extending between the hub and collar and the outer blade extending from the collar. A generator ring is carried by the collars and includes a generator rotor attached to the collars to rotate with the turbine rotor. A stator ring is supported from the generator rotor by a low friction interface with stationary positioning against the rotation of the generator rotor. A torque stay system prevents rotation of the stator ring for generation of power from the rotating turbine rotor as a linear distributed generator.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is an isometric view of a wind turbine employing an embodiment with a stayed rotor incorporating a direct drive generator;

FIG. 2 is a detailed partial isometric view of the rotor disc and direct drive generator ring including the transition between the inner and outer blades at the blade collar at the generator ring;

FIG. 3 is a detailed view of the blade collar;

FIG. 4 is a side partial section view of the blade collar and adjacent portions of the outer and inner blades;

FIG. 5 is a partial front section view of the blade collar;

FIG. 6 is an isometric view of the blade collar and partial outer and inner blades in operating pitch with a section view of the generator ring;

FIG. 7 is an isometric section view of the generator ring;

FIG. 8A is a detailed isometric section view of the generator ring;

FIG. 8B is a detailed side section view of the generator ring;

FIG. 9 is a detailed partial section view of the generator ring;

FIG. 10A is an isometric view of the stator torque stay system with the rotor and rotor forestay system removed for clarity;

FIG. 10B is an isometric view of the rotor forestay system with the stator torque stay system removed for clarity; and,

FIG. 11 is a front view of the combined stator torque stay system and rotor forestay system;

### DETAILED DESCRIPTION

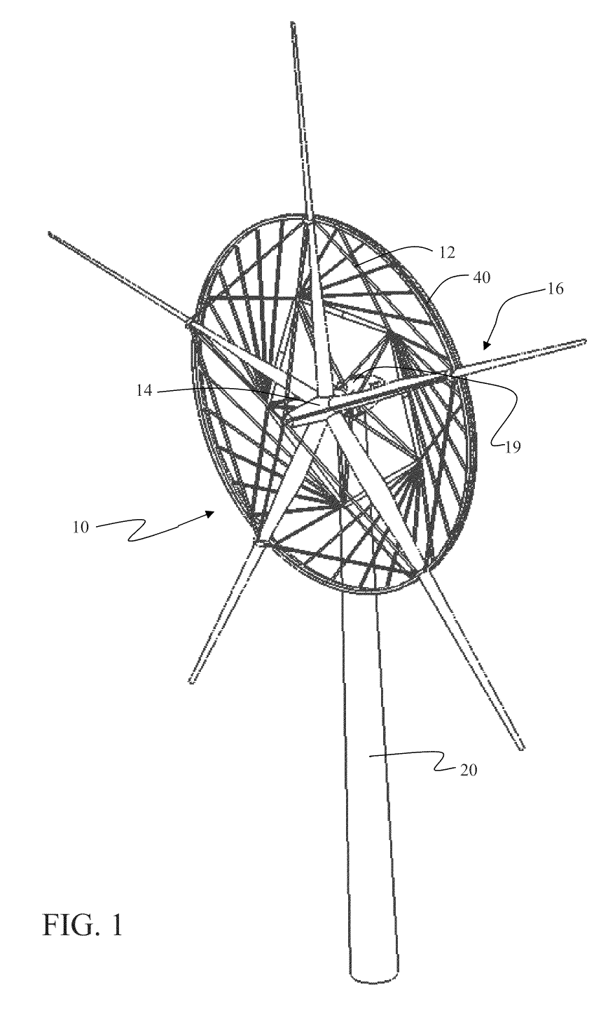

Embodiments of the invention incorporate a very large scale (˜10 MW) wind turbine multi-blade rotor 10 as shown in FIG. 1. Each blade 16 is constrained through a system of stay cables 12 from a rotor hub 14 attaching to a point ⅓ to ½ of the length of each blade from the hub. A collar 18 on each blade provides the attachment points for the stay cable system as will be described in greater detail subsequently. Each collar is also connected by stay cables to the adjoining blades' collars. A bearing system in the collar allows for the blade to have full pitch movement. The cable-stayed blade enables much greater swept area and lower cost than is currently possible with blades joined solely at the blade root to the hub. The rotor is supported by a nacelle 19 mounted from the ground by a tower 20.

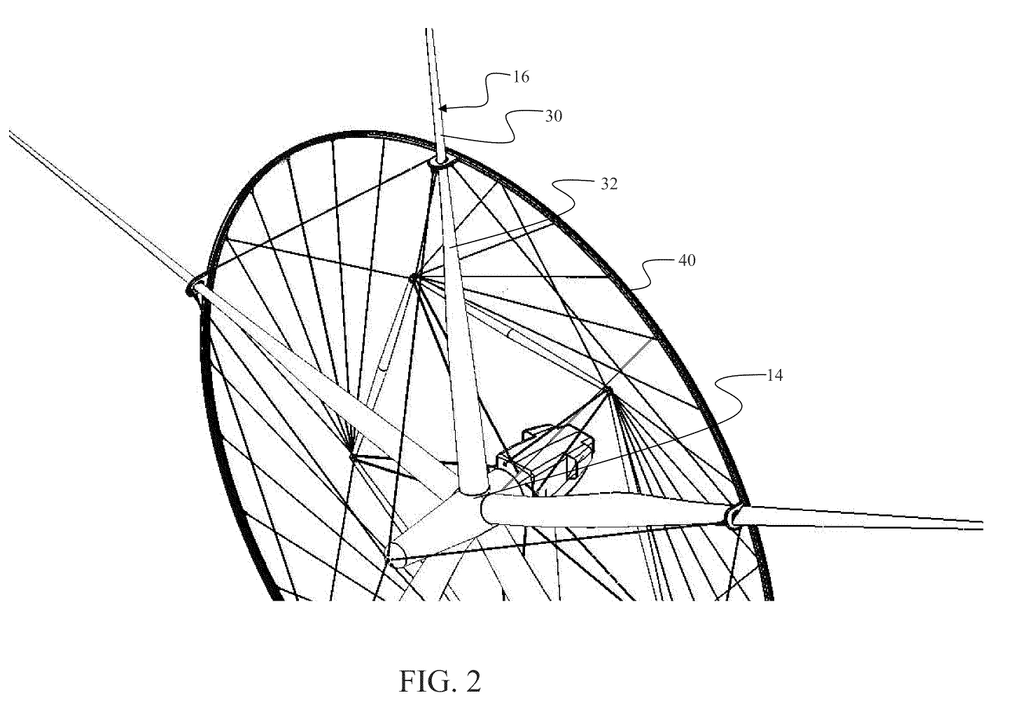

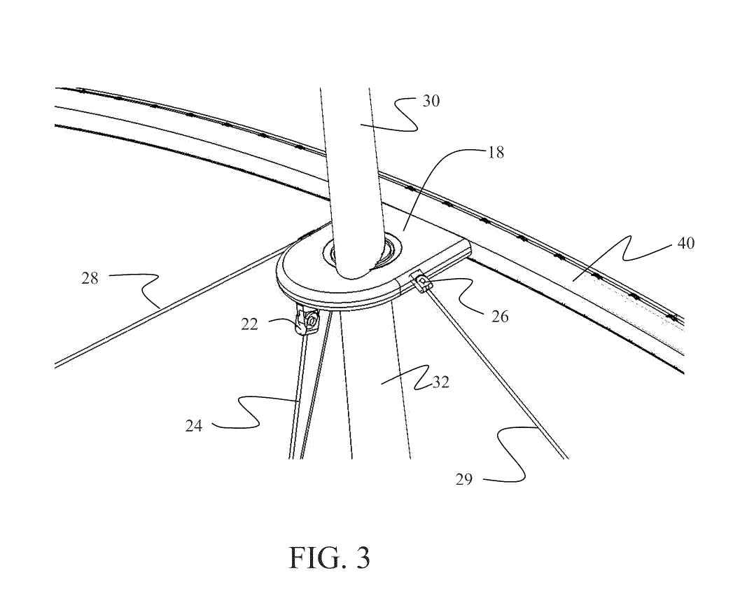

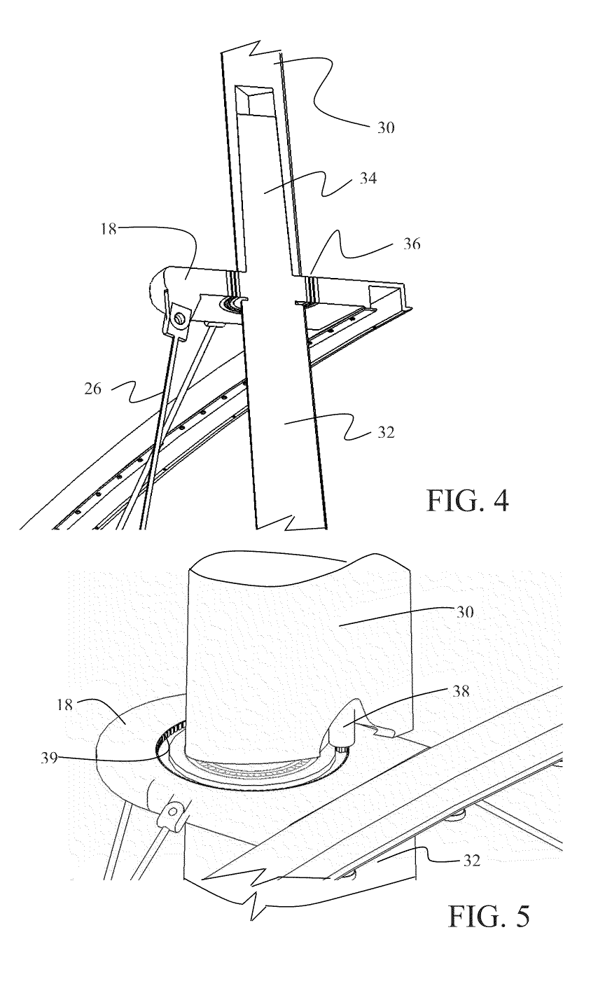

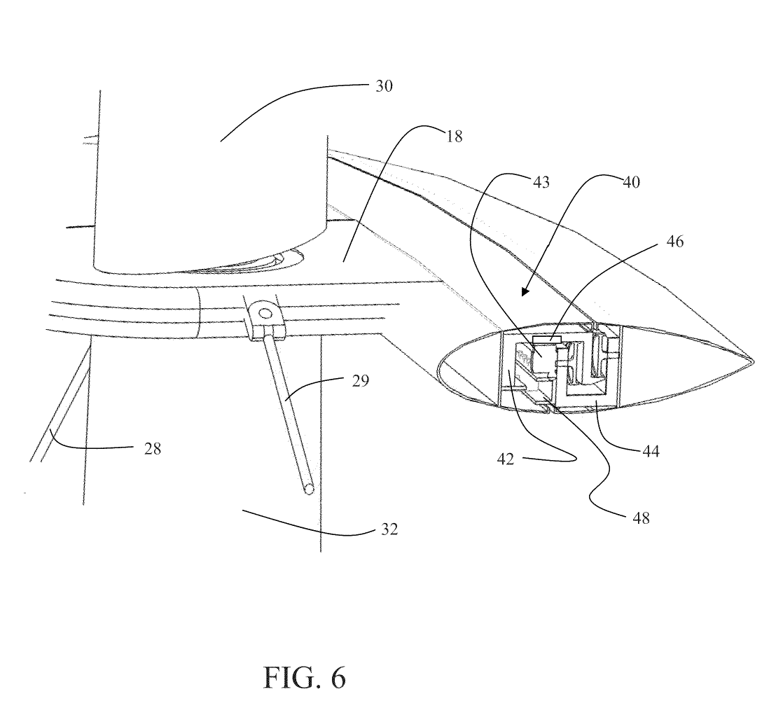

As seen in FIGS. 2 and 3, each collar 18 incorporates a first attach point 22 for a forestay cable 24 and opposing side attach points 26 for interblade lead and lag stay cables 28, 29. As previously described, the collar is positioned at a point approximately ⅓ to ⅔ of the blade length creating an outer blade portion 30 and an inner blade portion 32. As seen in FIG. 4, the outer and inner blade portions are joined by an axle 34 which extends through the collar. A blade pitch bearing 36 as shown in FIG. 4 rotationally constrains the blades within the collar allowing for pitch change using a blade pitch drive as shown in FIG. 5. As an exemplary embodiment, the pitch drive incorporates an electric motor 38 with a splined shaft driving a ring gear 39 concentric to the bearing.

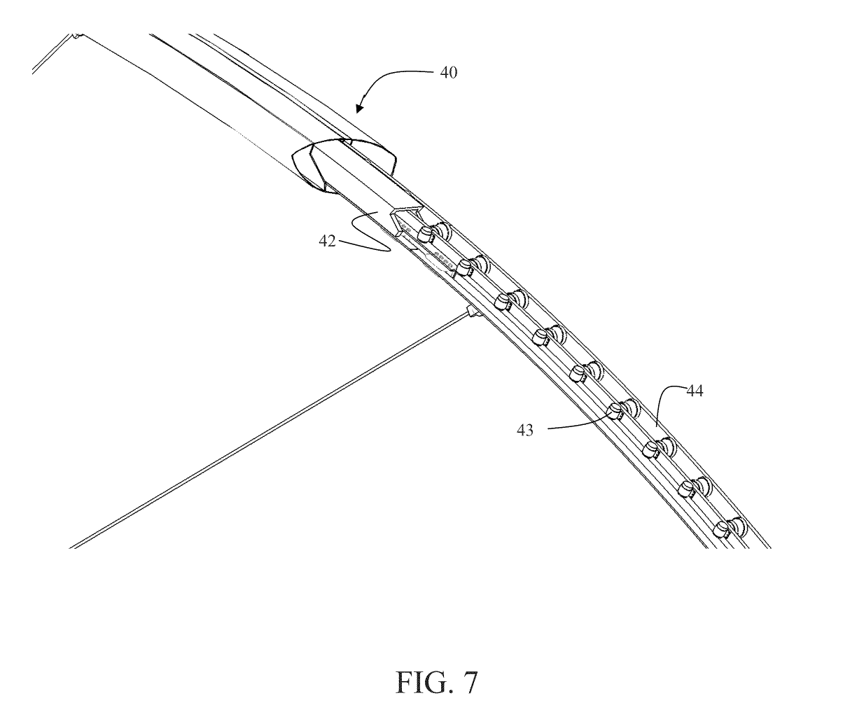

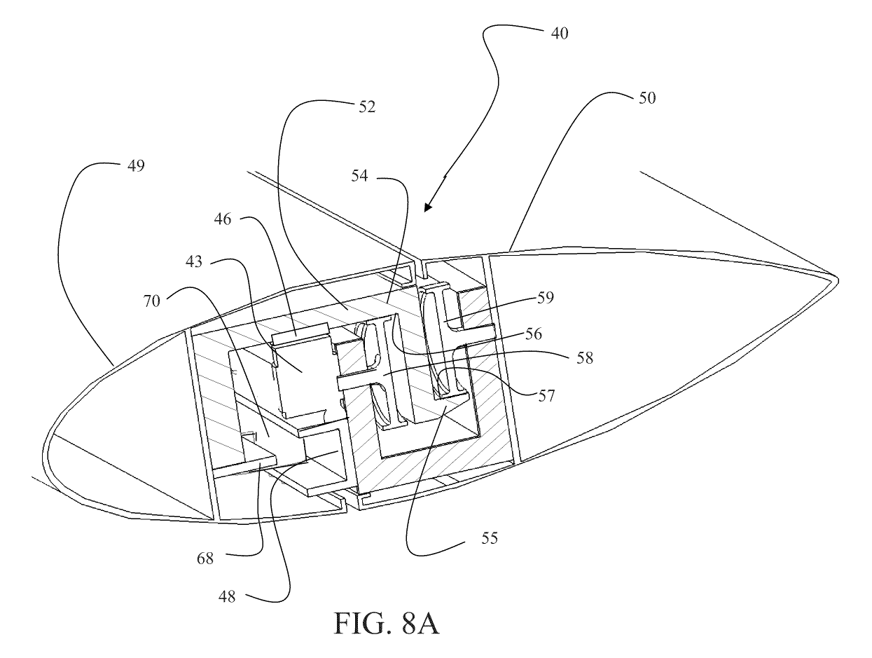

As shown in detail in FIG. 6, a generator ring 40 is carried by the trailing edge of the collar 18 with a generator rotor 42 fixed to the collar and multiple generator stator coils 43 carried by a stator ring 44 supported from the rotor with a low friction interface such as wheeled carriers described in greater detail subsequently. As shown in FIG. 6 and additionally in FIG. 7, the generator ring creates a linear distributed generator in the form of a large diameter annular (˜80 m) ring, which may be segmented into a series of linear generators comprising the annular ring. The generator rotor and stator ring are carried by the blade collars on the downwind side of the rotor forming joined, rigid concentric rings—one stationary (the stator ring), the other, the generator rotor, rotating with the turbine rotor. For the embodiments shown, the rings are fabricated of composite material with an approximate radius equal to the distance from the hub center of the turbine rotor to the collars. The rigid composite rotor contains permanent magnets 46 on the full inner periphery of the ring to create the rotor of the generator system. The close-fitting composite stator ring supports wound electromagnet stator coils 43. For the embodiment shown, a channel 48 on which the stator coils are mounted extends from the upwind side of the stator ring. In alternative embodiments, the stator ring is fabricated in segments of a composite material with the wound electromagnets imbedded and joined to form a full ring. The interchangeable stator coils or segments allow easy initial fabrication and assembly as well as modular repair capability. Aerodynamic fairings 49 and 50 cover the generator rotor and stator ring, respectively. While a five blade rotor is employed in the exemplary embodiment alternative blade counts are anticipated in other embodiments.

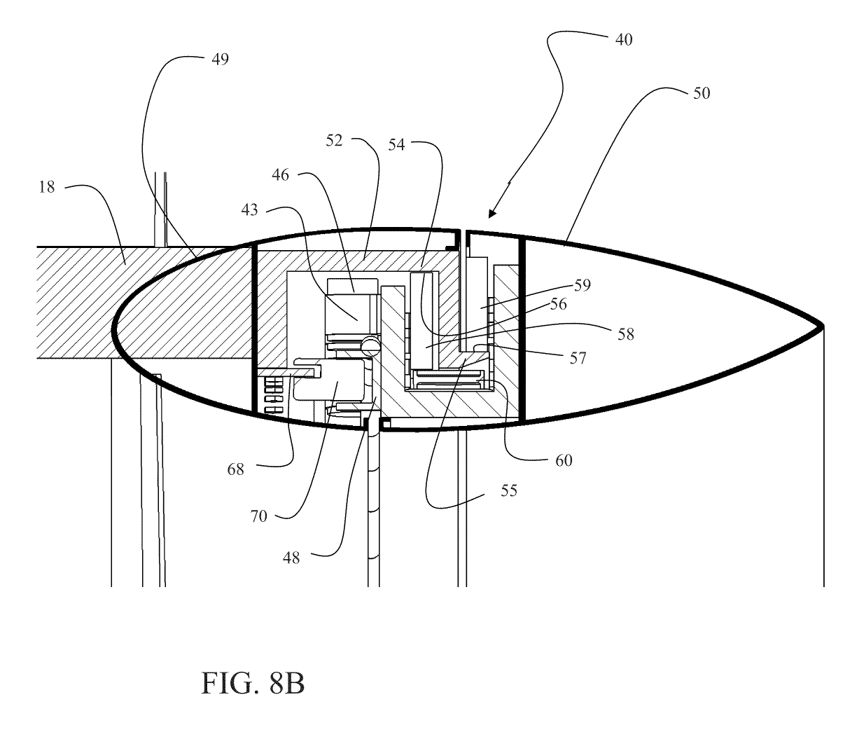

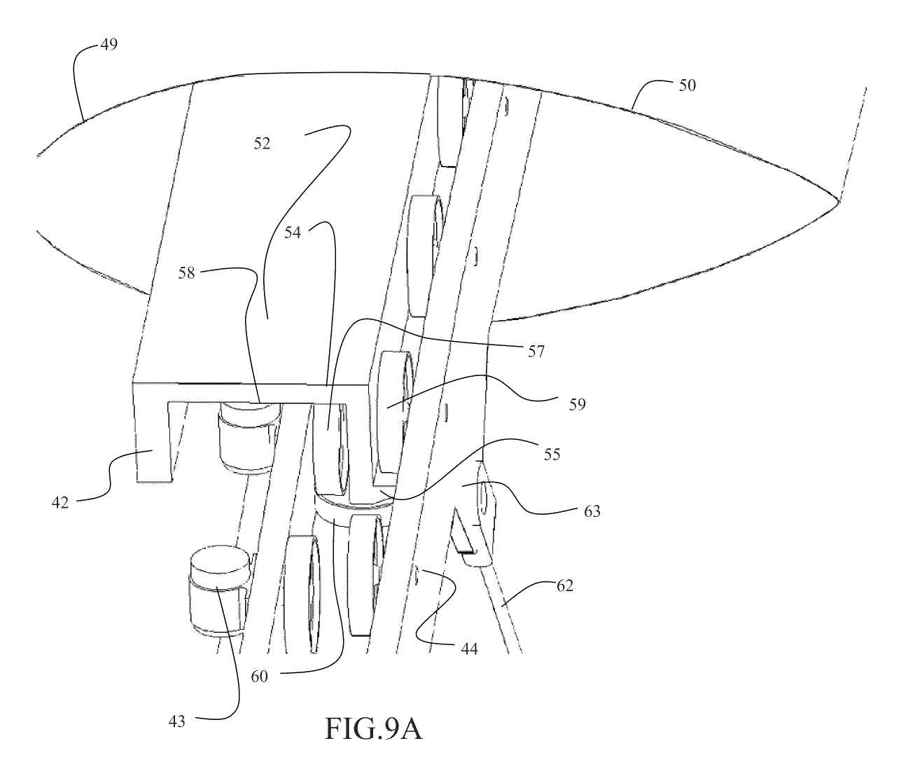

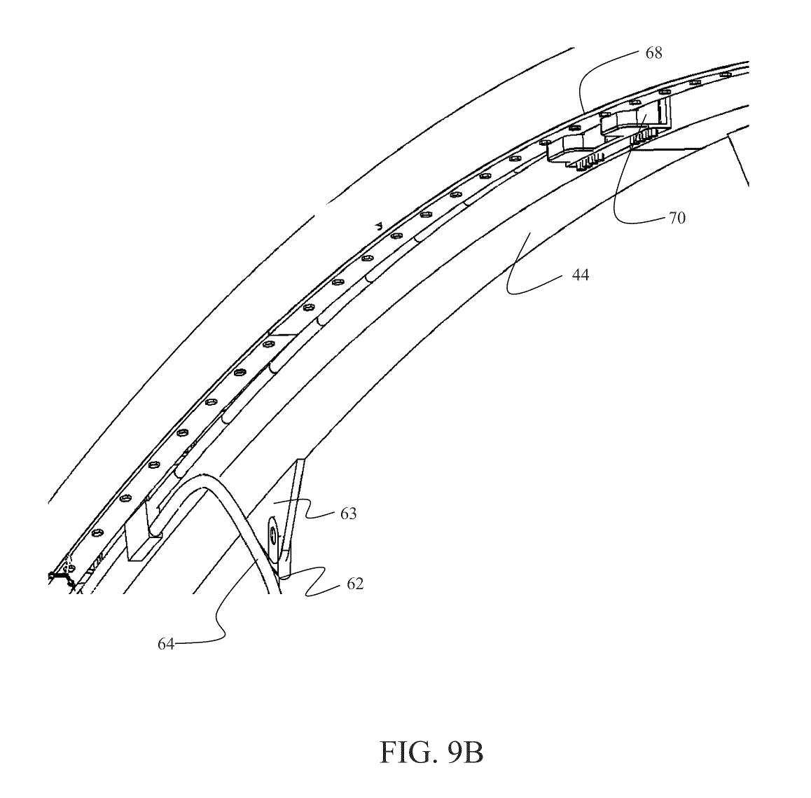

As best seen in FIGS. 8A, 8B and 9A, the rigid composite generator ring also employs a low friction interface with dual track wheels that roll between the generator rotor and stator ring and are configured to maintain a close uniform gap and distribute the loads over the entire generator perimeter. The generator rotor engages the stator ring on the track wheels, thereby maintaining the required gap between the embedded magnets and the mounted coils. A structural interface 52 extending from each blade collar provides an inner track 54 and an outer track 55 having opposing upper and lower bearing surfaces 56, 57 respectively. Support wheels 58 and 59 extending from the sides of the U-shaped stator ring ride in the opposing inner and outer tracks. Thrust wheels 60, having a rotational plane substantially perpendicular to the support wheels, extend from the bottom the structural interface to engage the sides of the stator ring to provide lateral stability and interengagement for the elements of the generator ring to assure structural integrity and reduce frictional loads imposed by thrust loads created by the turbine rotor. Placement of the support wheel pairs immediately adjacent the stator coils supported by the stator ring enhances the gap control between the stator coil surface and the embedded magnets in the rotor as the stator and magnet transition past one another during rotation.

While carried by the generator rotor through the low friction interface, which may be support wheels, as shown for the currently disclosed embodiment, magnetic bearings or fluidic bearings, the stator ring is maintained stationary by torque-stay cables 62 attached to tangs 63 on the stator ring which connect to the machine base, as will be described in greater detail subsequently, restraining the drag on the stator ring, and keeping the stator ring from rotating with the generator rotor. As shown in FIG. 9B, attached to or carried within the torque cables are the power cables 64 to transmit electricity from each linear stator segment to the power conditioning system on the wind turbine, and from there, to interconnection with the power grid. For the embodiment shown in the drawings, the torque stay cables attach to connection points 66 on the on the stator ring.

As shown in FIGS. 8A, 8B and 9A the structural interface 52 additionally includes a brake rim extension 68 which is received in disc brake calipers 70 carried within the channel extending from the stator ring. Power cabling for activation of disc brakes may also be carried by the stay cables as previously described. Activation of the brakes allows the torque stay cabling system of the stator ring to slow, stop and restrain the turbine rotor with the blades feathered or slightly positively pitched to maintain tension. Placing a braking system at the diameter of the generator ring provides significant enhancement of braking capability and efficiency.

In alternative embodiments, the braking system may employ the stator coils and rotor magnets for electromagnetic braking.

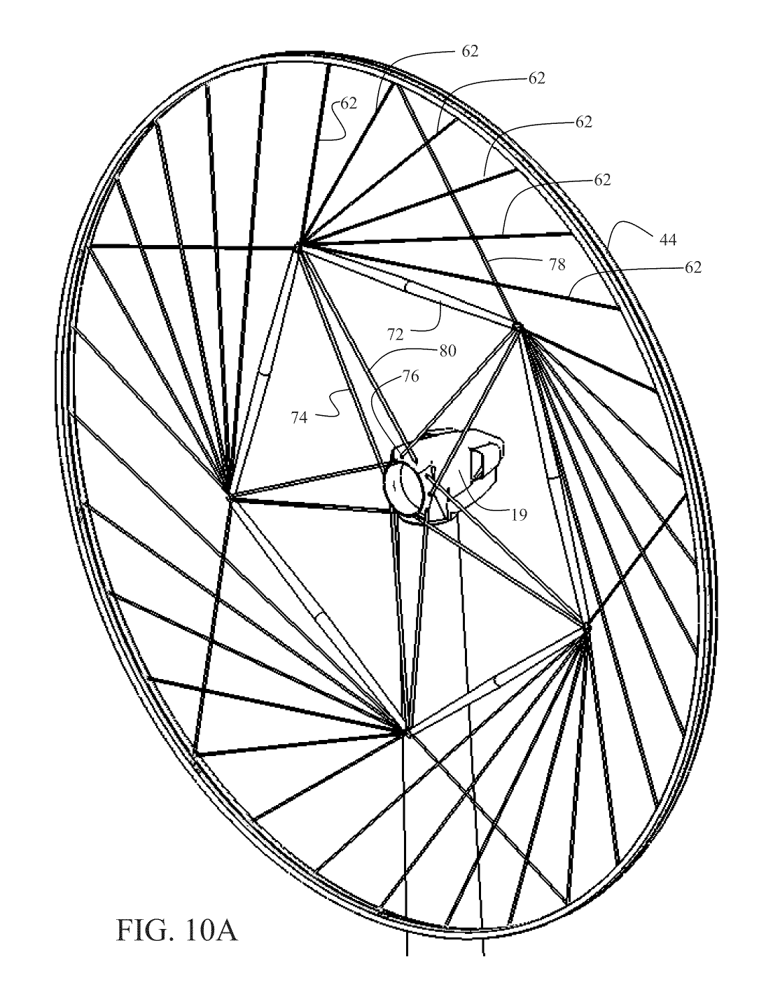

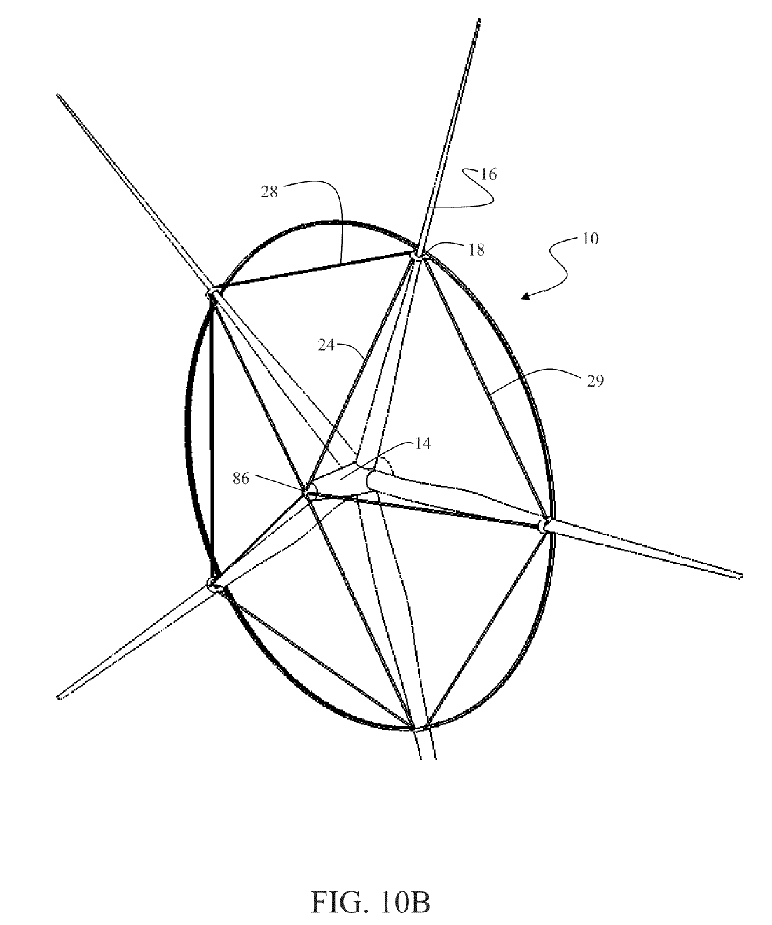

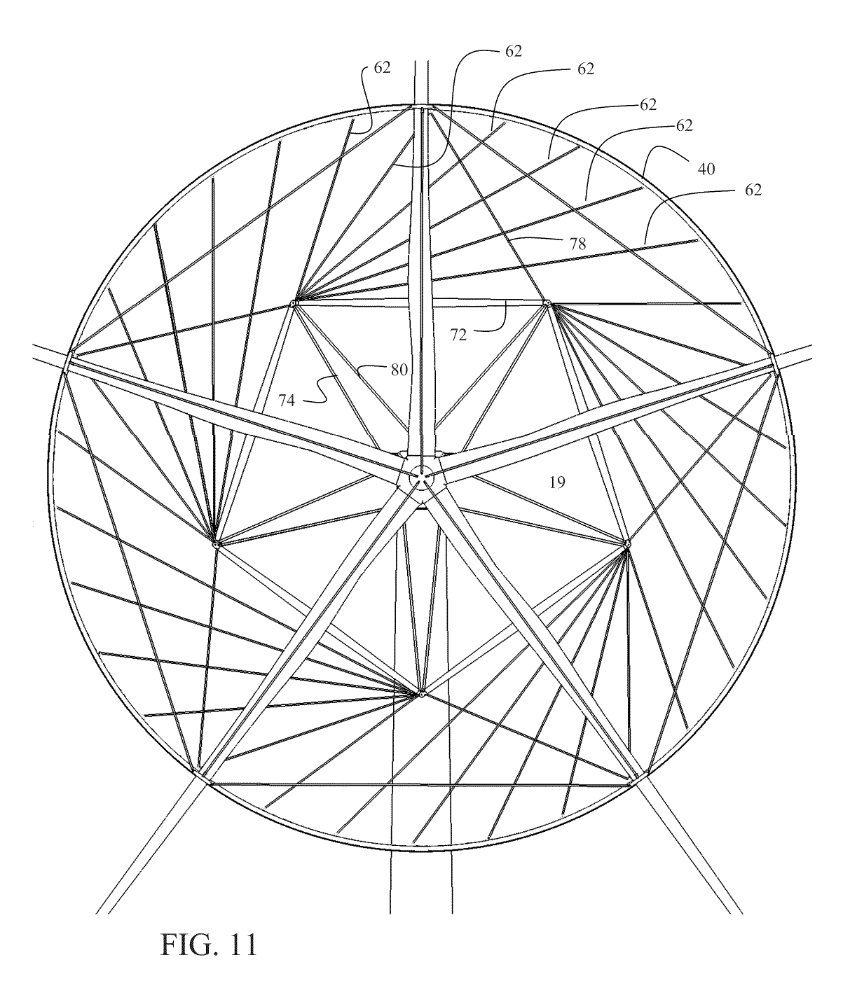

The torque stay cabling system and turbine rotor forestay cabling system are show in detail in FIGS. 10A, 10B and 11. Rotation of the stator ring 44 is prevented by a stator torque stay system repeated for the arc of the generator ring. Torque stay cables 62 extending inward from the stator ring to a torque stay spreader ring 72. Inner torque stay cables 74 extend from the torque stay spreader ring to stationary structural supports 76 on the turbine main shaft housing within the nacelle 19 adjacent the interface with the rotor hub. The torque stay spreader ring provides efficient leverage angles for the torque stay cable attachment to the stator ring. Complimentary outer and inner anti-rotation guy wires 78, 80 balance the outer and inner torque stay cables 62, 74 to prevent relative rotation between the stator ring and spreader ring relative to the support ring when the generator rotor carried by the turbine rotor is not exerting torque on the stator ring. For the embodiment shown, the spreader ring is created with linear segments 72a, 72b, 72c, 72d and 72e and torque stay cables 62a, 62b, 62c, 62d, 62e and 62f for the arc segment of the stator ring are attached at a common point at the vertex of adjacent segments. Six stay cables for each arc provide engagement of the stator ring at 12 degree spacing along the ring, however, other embodiments may use more or fewer than five arc segments for the stator ring. The initial torque stay cable 62a in each arc is aligned with the prior segment 72e of the spreader at the vertex. The outer antirotation guy wire 78 in each arc attaches to the stator ring at a common point with the second torque stay cable 62b and is attached at the trailing vertex of the of the spreader ring segment 72a. In alternative embodiments, a circular spreader ring may be employed with substantially tangential attachment of the stay cables.

As best seen in FIG. 108, the blades 16 in rotor 10 are connected at collars 18 with forestay cables 24 extending forward and inward to a structural support 86 on the nose of the rotor hub 14. Complimentary leading and trailing lead/lag stay cables 28, 29 balance each blade with respect to the adjacent blades for enhanced structural efficiency of the rotor forestay system.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A wind turbine power generation system comprising:
a turbine rotor having a plurality of blades extending from a hub, each blade having an inner blade and an outer blade;
a collar on each blade with the inner blade extending between the hub and collar and the outer blade extending from the collar;
a generator ring carried by the collars and having
a generator rotor attached to the collars, and
a stator ring supported from the generator rotor by a low friction interface; and,
a torque stay system preventing rotation of the stator ring.

2. The wind turbine power generation system as defined in claim 1 further comprising a forestay system attached to the collars.

3. The wind turbine power generation system as defined in claim 1 wherein the torque stay system comprises:
a plurality of outer torque stay cables interconnecting the stator ring and a torque stay spreader ring; and
a plurality of inner torque stay cables interconnecting the torque stay spreader ring and a structural support on a housing of the turbine rotor main shaft adjacent the rotor hub.

4. The wind turbine power generation system as defined in claim 3 further comprising:
a plurality of complimentary outer and inner anti-rotation guy wires interconnecting the stator ring, torque stay spreader ring and structural support ring.

5. The wind turbine power generation system as defined in claim 4 wherein the torque stay spreader ring comprises a plurality of interconnected linear segments and the torque stay cables connect at interconnecting vertices of the segments.

6. The wind turbine power generation system as defined in claim 5 wherein each outer torque stay cable and associated outer anti-rotation guy wire attach to a substantially common point on the stator ring.

7. The wind turbine power generation system as defined in claim 1 wherein the collar on each blade is between ⅓ and ⅔ of the blade length from the blade root.

8. The wind turbine power generation system as defined in claim 2 wherein the forestay system comprises:
a forestay cable interconnecting each collar and a nose of the blade hub; and
lead and lag cables interconnecting each collar to adjacent collars.

9. The wind turbine power generation system as defined in claim 6 wherein the angular displacement of the outer and inner stay cables with respect to the stay spreader ring is sufficient to provide at least 180 degrees of offset between the attachment points on the support ring for each inner stay cable and the second structural support ring for tangential attachment.

10. The wind turbine power generation system as defined in claim 1 wherein the low friction interface comprises:
a plurality of dual track wheels that roll between the generator rotor and stator ring and are configured to maintain a close uniform gap and distribute the loads over a perimeter of the entire generator rotor.

11. The wind turbine power generation system as defined in claim 10 wherein each blade collar includes a structural interface with an inner track and an outer track having opposing upper and lower bearing surfaces respectively and said plurality of wheels include inner and outer wheels carried by the stator ring positioned to ride in the opposing inner and outer tracks.

12. The wind turbine power generation system as defined in claim 10 wherein the stator ring carries a plurality of spaced stator coils, said stator coils segmented in discreet arcs comprising the stator ring and the generator rotor carries a plurality of embedded magnets for interaction with the stator coils, said dual track wheels mounted adjacent said stator coils.

13. The wind turbine power generation system as defined in claim 11 further comprising a means for braking the rotor with respect to the stator.

14. The wind turbine power generation system as defined in claim 13 wherein the braking means comprises a brake rim included on the structural interface and at least one brake caliper is carried by the stator ring receiving the brake rim.

15. The wind turbine power generation system as defined in claim 10 wherein each blade collar includes a structural interface with an inner track and an outer track having opposing upper and lower bearing surfaces respectively and said plurality of wheels include inner and outer wheels carried by the stator ring positioned to ride in the opposing inner and outer tracks, the stator ring carrying a plurality of spaced stator coils and the generator rotor carrying a plurality of embedded magnets for interaction with the stator coils, said dual track wheels mounted adjacent said stator coils and further comprising a plurality of thrust wheels having a plane of rotation substantially perpendicular to the dual track wheels carried by the structural interface for engagement of the stator ring.

16. A wind turbine power generation system comprising:
a turbine rotor having a plurality of blades extending from a hub each blade having an inner blade and an outer blade;
a collar on each blade with the inner blade extending between the hub and collar and the outer blade extending from the collar;
a generator ring carried by the collars and having
a generator rotor attached to the collars with a support structure having opposing inner and outer tracks and carrying a plurality of thrust wheels, said generator rotor having a plurality of spaced embedded magnets, and
a stator ring having a plurality inner and outer wheels carried to ride in the opposing inner and outer tracks, the stator ring further carrying a plurality of spaced stator coils mounted adjacent said inner and outer wheels, said thrust wheels engaging the stator ring; and,
a torque stay system preventing rotation of the stator ring and having a plurality of outer torque stay cables interconnecting the stator ring and a torque stay spreader ring; and
a plurality of inner torque stay cables interconnecting the torque stay spreader ring and a structural support ring mounted to a cab adjacent the rotor hub;
a plurality of complimentary outer and inner anti-rotation guy wires interconnecting the stator ring, torque stay spreader ring and structural support ring;
a forestay cable interconnecting each collar and a nose of the blade hub; and
lead and lag cables interconnecting each collar to adjacent collars.

17. A method for wind power generation comprising:
providing a turbine rotor having a plurality of blades extending from a hub each blade having an inner blade and an outer blade;
placing a collar on each blade with the inner blade extending between the hub and collar and the outer blade extending from the collar;
a mechanism positioned at the collar to enable the inner and outer blades to be pitched;
providing a generator ring with a generator rotor attached to the collars;
supporting a stator ring from the generator rotor by a low friction interface for relative rotation with the generator rotor; and,
restraining the stator ring with a torque stay system preventing rotation of the stator ring.

18. The method defined in claim 17 wherein the step of supporting a stator ring comprises:
attaching a plurality of dual track wheels to a stator ring;
engaging inner and outer opposing tracks on a support structure incorporated in the generator rotor with the dual track wheels;
attaching a plurality of thrust wheels to the support structure to engage the stator ring; and,
providing the stator ring with a plurality of arc segments with electromagnets, with each segment as a discreet linear generator stator delivering electric power to via electric cable attached to the torque stay cables and then to power conditioning equipment within the nacelle.

19. The method as defined in claim 17 wherein the step of restraining the stator ring comprises:
interconnecting the stator ring and a torque stay spreader ring with a plurality of outer torque stay cables; and
interconnecting the torque stay spreader ring and a structural support ring mounted to the rotor main shaft housing adjacent the rotor hub with a plurality of inner torque stay cables;
interconnecting the stator ring, torque stay spreader ring and structural support ring with a plurality of complimentary outer and inner anti-rotation guy wires.

20. The method as defined in claim 17 further comprising:
interconnecting each collar and a nose of the blade hub with a forestay cable; and
interconnecting each collar to adjacent collars with lead and lag cables.
